(19) United States
(12) Patent Application Publication
(10) Pub. No.: US 2024/0023518 A1
(43) Pub. Date: Jan. 25, 2024

(54) Dog-Weaning Garment Device

(71) Applicant: Caroline Whitehouse, Fort Pierce, FL (US)

(72) Inventor: Caroline Whitehouse, Fort Pierce, FL (US)

(21) Appl. No.: 18/335,299

(22) Filed: Jun. 15, 2023

Related U.S. Application Data
(60) Provisional application No. 63/391,475, filed on Jul. 22, 2022.

(51) Int. Cl. A01K 13/00

(52) U.S. Cl. CPC A01K 13/006

(57) ABSTRACT

The present invention relates to a dog-weaning garment device that can be worn by a mother dog while weaning her puppies. The device is primarily comprised of a body with at least one leg opening, at least one body opening, at least one pad, and at least one first strap that connects to at least one second strap. The device can be worn by a mother dog during the weaning period to protect the mother dog's nipples from being suckled by weaning puppies. The pad further absorbs any lactate produced by the mother dog.

### CROSS-REFERENCE TO RELATED APPLICATION

The present application claims priority to, and the benefit of, U.S. Provisional Application No. 63/391,475, which was filed on Jul. 22, 2022, and is incorporated herein by reference in its entirety.

### FIELD OF THE INVENTION

The present invention relates generally to the field of animal garments. More specifically, the present invention relates to a dog-weaning garment device primarily comprised of a body with at least one leg opening, at least one body opening, at least one pad, and at least one first strap that connects to at least one second strap. The device can be worn by a mother dog during the weaning period to protect the mother dog's nipples from being suckled by weaning puppies. The pad further absorbs any lactate produced by the mother dog. Accordingly, the present disclosure makes specific reference thereto. Nonetheless, it is to be appreciated that aspects of the present invention are also equally applicable to other like applications, devices, and methods of manufacture.

### BACKGROUND

Nursing puppies and other animals must eventually be weaned from feeding from their mother. During the weaning process, puppies may continuously try to suckle. This constantly stimulates the nipples of the mother dog and therefore does not allow the mother dog to stop lactating. To prevent constant suckling during the weaning process, a mother dog and her puppies have to be separated for periods of time. However, this separation causes stress to the mother and puppies. In addition, taking a mother away from her puppies too early can result in a more anxious, nervous, and/or unstable adult dog when puppies grow up.

During the weaning process it is very hard to keep the puppies from trying to suckle, which ultimately results in the mother dog and puppies having to be separated from 5 weeks old, so that the mother can dry up and the puppies can be weaned.

It is extremely stressful for the mother and puppies, the mother paces and cries for her puppies trying to get to them and the puppies also cry continually for many days. Studies show that removing a puppy from its mother too young causes great anxiety and results in a more anxious adult dog and also other negative issues caused by psychological damage that can result in negative character traits in an adult dog. It also affects the mother dog long term due to this long term trauma experienced.

This is repeatedly seen in puppies purchased from puppy mills where the puppies have the least contact with their mother. There are new breeding practices where certain stimulation exposure to touch, noises and other contact, as well as prolonged contact with the mother is producing amazingly stable adult dogs.

Dramatic changes to puppies at a young age causes great psychological damage, resulting in long term negative character traits in an adult dog making it less stable, this is why it is actually illegal to adopt a puppy before it is 8 weeks old in most places.

Animals are naturally meant to stay together in their pack until full adulthood, where they either stay within the pack or leave to form a new pack, they are not meant to be separated at such a young age, although puppies will be adopted into their new family, it is essential to make this transition as smooth as possible until the puppy and mother is ready to leave.

Although the importance of this is now being recognized there are still issues of keeping the mother and puppies together 24/7 due to the puppies intense desire to continually suckle, therefore constantly stimulating the nipples and preventing them from drying up and therefore preventing the mother to get back to normal and also slowing the transition of the puppies moving from milk to solids and therefore causing issues and stress when they are adopted to their new family.

Therefore, there exists a long-felt need in the art for a device that can be used during the weaning process. More specifically, there exists a long-felt need in the art for a dog-weaning garment device that can be worn by a mother dog during the weaning process to prevent suckling. There also exists a long-felt need in the art for a dog-weaning garment device that can be worn by a mother dog during the weaning process that does not require separating a mother dog from her puppies during weaning. In addition, there exists a long-felt need in the art for a dog-weaning garment device that can be worn by a mother dog during the weaning process that absorbs excess milk or liquid produced by a lactating mother dog.

The subject matter disclosed and claimed herein, in one embodiment thereof, comprises a dog-weaning garment device. The device is primarily comprised of a body with at least one leg opening, at least one body opening, at least one pad, and at least one first strap that connects to at least one second strap. The device can be worn by a mother dog during the weaning period. The body of the device protects the mother dog's nipples from being suckled by weaning puppies. The pad further absorbs any lactate produced by the mother dog. The device is secured around the mother dog's body via the straps. Different patterns and colors can also be put on the wrap.

This weaning wrap means that the mother does not need to be removed from the puppies for even one hour, and weaning can be controlled by putting on and removing the wrap when desired while being in the presence of the mother at all times until the puppies are fully weaned and are ready to be adopted. The mother also has space in the wrap to use the bathroom and for excess leaking from nipples to be absorbed into the absorbent pads, the wrap is also made from a washable material and the multiple straps are adjustable to fit all body sizes and shapes.

In this manner, the dog-weaning garment device of the present invention accomplishes all of the foregoing objectives and provides a device that can be used during the weaning process. During the weaning process, the device can be worn by a mother dog to cover the dog's nipples to prevent suckling. The device advantageously does not require separating a mother dog from her puppies during the weaning process and also absorbs excess milk or liquid produced by a lactating mother dog.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dog-weaning garment device. The device is primarily comprised of a body with at least one leg opening, at least one body opening, at least one pad, and at least one first strap that connects to at least one second strap. The body is preferably made from a fabric material. The fabric material preferably has some degree of stretch or flexibility to allow the device to comfortably fit any size, age, and breed of dog or animal.

The body is also comprised of at least one absorbent pad made from any absorbent material known in the art. The pad is positioned on the body such that it contacts the underbelly and front chest area of a dog while the device is worn. As a result, any milk that may flow from a lactating dog wearing the device is absorbed by the pad.

The body has at least one leg opening that allows the leg of the dog to protrude through the device and move in an uninhibited manner. The opening may be made from an elastic material in one embodiment to ensure a proper fit around the legs of the dog. The body is also comprised of at least two body openings that allow the head/neck area and the buttocks of the dog to protrude from the device. This allows the dog to urinate and defecate without soiling the device in addition to moving their head/neck freely.

The device is also comprised of a first strap and a second strap. The first strap is preferably fixedly attached to the body. In one embodiment, the strap is of a fixed length. In another embodiment, the strap is comprised of at least one adjustment fastener that can be manipulated to allow the strap to lengthen or shorten. The second strap is also preferably fixedly attached to the body. The second strap may be of a fixed length or may be comprised of at least one adjustment fastener that can be manipulated to allow the strap to lengthen or shorten.

The first strap is preferably comprised of at least one male fastener. The second strap is preferably comprised of at least one female fastener. The female fastener receives the male fastener to allow the first strap to attach to the second strap. While worn by a dog, the straps preferably attach to a strap body such that the device is secured around the dog.

Accordingly, the dog-weaning garment device of the present invention is particularly advantageous as it provides a device that can be used during the weaning process. During the weaning process, the device can be worn by a mother dog to cover the dog's nipples to prevent suckling. The device also does not require separating a mother dog from her puppies during the weaning process and also absorbs excess milk or liquid produced by a lactating mother dog. In this manner, the dog-weaning garment device provides a novel solution to dog weaning.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a dog-weaning garment device of the present invention while worn by a dog in accordance with the disclosed architecture; and

FIG. 2 illustrates a perspective view of one potential embodiment of a dog-weaning garment device of the present invention while unattached in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used during the weaning process. More specifically, there exists a long-felt need in the art for a dog-weaning garment device that can be worn by a mother dog during the weaning process to prevent suckling. There also exists a long-felt need in the art for a dog-weaning garment device that can be worn by a mother dog during the weaning process that does not require separating a mother dog from her puppies during weaning. In addition, there exists a long-felt need in the art for a dog-weaning garment device that can be worn by a mother dog during the weaning process that absorbs excess milk or liquid produced by a lactating mother dog.

The present invention, in one exemplary embodiment, is comprised of a dog-weaning garment device primarily comprised of a body with at least one leg opening, at least one body opening, at least one pad, and at least one first strap that connects to at least one second strap. The body is preferably made from a fabric material. The fabric material preferably has some degree of stretch or flexibility to allow the device to comfortably fit any size, age, and breed of dog or animal.

The body is also comprised of at least one absorbent pad made from any absorbent material known in the art. The pad is positioned on the body such that it contacts the underbelly and front chest area of a dog while the device is worn. Accordingly, any milk that may flow from a lactating dog wearing the device is absorbed by the pad.

The body also has at least one leg opening that allows the leg of the dog to protrude through the device and move in an uninhibited manner. The opening may be made from an elastic material in one embodiment to ensure a proper fit around the legs of the dog. The body is also comprised of at least two body openings that allow the head/neck area and the buttocks of the dog to protrude from the device to allow the dog to urinate and defecate without soiling the device in addition to moving their head/neck freely.

The device is also comprised of a first strap and a second strap. Both straps are preferably fixedly attached to the body. In one embodiment, the straps are of a fixed length. In another embodiment, the straps are comprised of at least one adjustment fastener that can be manipulated to allow the strap to lengthen or shorten.

The first strap is preferably comprised of at least one male fastener. The second strap is preferably comprised of at least one female fastener. The female fastener receives the male fastener to allow the first strap to attach to the second strap. While worn by a dog, the straps preferably attach to a strap body such that the device is secured around the dog.

Accordingly, the dog-weaning garment device of the present invention is particularly advantageous as it provides a device that can be used during the weaning process. During the weaning process, the device can be worn by a mother dog to cover the dog's nipples to prevent suckling. The device also does not require separating a mother dog from her puppies during the weaning process and also absorbs excess milk or liquid produced by a lactating mother dog. In this manner, the dog-weaning garment device provides a novel solution to dog weaning.

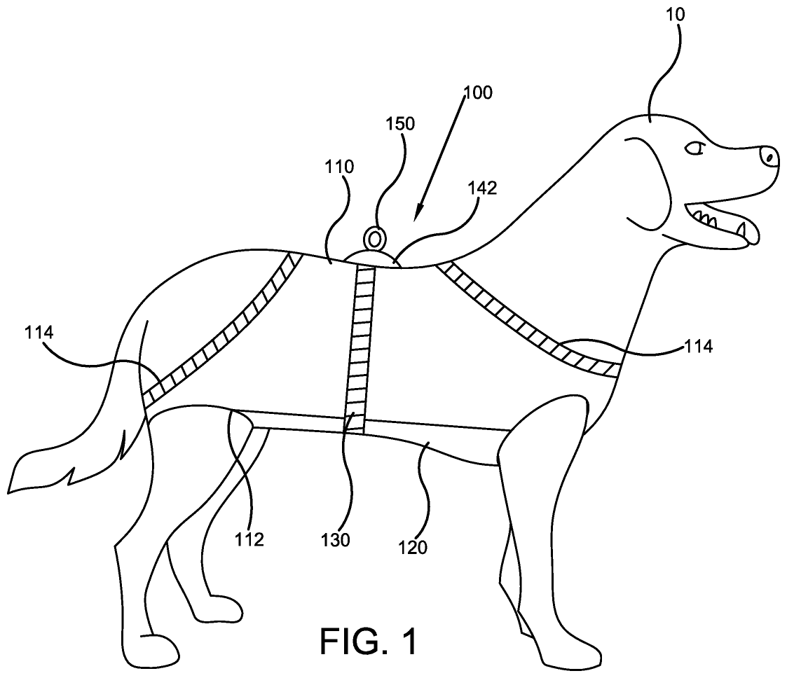

Referring initially to the drawings, FIG. 1 illustrates a perspective view of one potential embodiment of a dog-weaning garment device 100 of the present invention while worn by a dog 10 in accordance with the disclosed architecture. The device 100 is primarily comprised of a body 110 with at least one leg opening 112, at least one body opening 114, at least one pad 120, and at least one first strap 130 that connects to at least one second strap 140. The body 110 may be any size and shape known in the art to accommodate any size, age, and breed of dog 10. However, the device 100 may also be used on other animals that nurse their young via nipples.

The body 110 is preferably made from a fabric material. Said material includes, but is not limited to, vinyl, canvas, cashmere, chenille, chiffon, cotton, damask, jersey, lace, linen, wool, modal, polyester, satin, silk, spandex, suede, tweed, twill, velvet, acrylic, modacrylic, nylon, polypropylene, polyurethane, polyvinyl chloride, polyethylene, vinylidene, benzoate, aramid, rayon, acetate, triacetate, etc. In one embodiment, the fabric material is perforated for improved breathability and comfort. In another embodiment, the fabric material may be insulated for warmth of the dog 10. The fabric material preferably has some degree of stretch or flexibility. This allows the device 100 to comfortably fit any size, age, and breed of dog 10. However, some embodiments of the body 110 material may not have flexible or stretch properties.

The body 110 is also comprised of at least one absorbent pad 120. The pad 120 may be made from any absorbent material known in the art. The pad 120 is positioned on the body 110 such that it contacts the underbelly and front chest area of a dog 10 while the device 100 is worn. In this manner, any milk that may flow from a lactating dog 10 wearing the device 100 is absorbed by the pad 120. The body 110 is further preferably made from a washable material to allow the device 100 to be easily cleaned once the pad 120 has been saturated with milk/fluid.

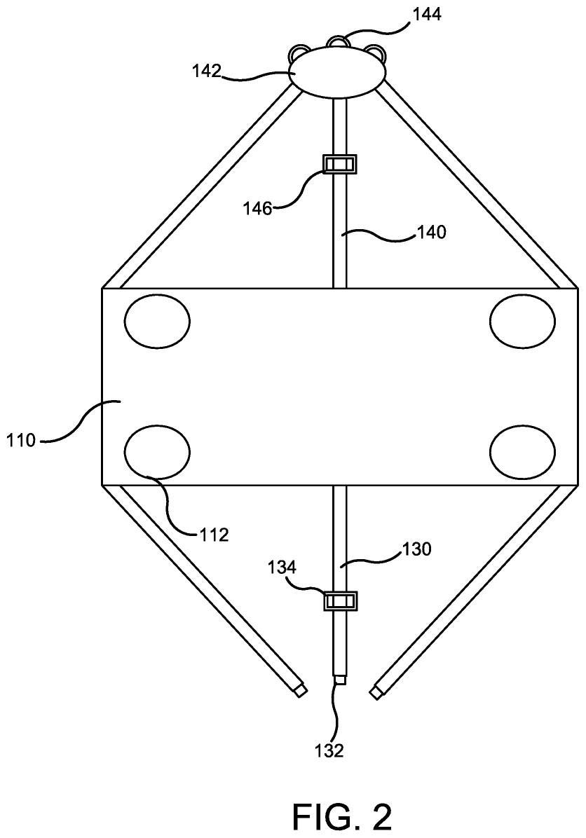

In the preferred embodiment, the body 110 has at least one leg opening 112, as best seen in FIG. 2. The opening 112 allows the leg of the dog 10 to protrude through the device 100 and move in an uninhibited manner. The opening 112 may be made from an elastic material in one embodiment to ensure a proper fit around the legs of the dog 10.

The body 110 is also comprised of at least two body openings 114. The body openings 114 allow the head/neck area and the buttocks of the dog 10 to protrude from the device 100. This allows the dog 10 to urinate and defecate without soiling the device 100 in addition to moving their head/neck freely. The openings 114 may be made from an elastic material in one embodiment to ensure a proper fit around the body of the dog 10.

The device 100 is also comprised of a first strap 130. The first strap 130 is preferably fixedly attached to the body 110. The first strap 130 may be made from any fabric material known in the art. The strap 130 may have elastic or flexible properties to allow the strap 130 to extend in length to fit a plurality of dog 10 sizes.

In one embodiment, the strap 130 is of a fixed length. In another embodiment, the strap 130 is comprised of at least one adjustment fastener 134. The adjustment fastener 134 can be manipulated to allow the strap 130 to lengthen or shorten. The adjustment fastener 134 may be, but is not limited to, a sliding buckle or any other buckle of the like.

The device 100 is also comprised of a second strap 140. The second strap 140 is preferably fixedly attached to the body 110. The second strap 140 may be made from any fabric material known in the art. The strap 140 may have elastic or flexible properties to allow the strap 140 to extend in length to fit a plurality of dog 10 sizes.

In one embodiment, the strap 140 is of a fixed length. In another embodiment, the strap 140 is comprised of at least one adjustment fastener 146. The adjustment fastener 146 can be manipulated to allow the strap 140 to lengthen or shorten. The adjustment fastener 146 may be, but is not limited to, a sliding buckle or any other buckle of the like. In one embodiment, the fastener 144 is attached to at least one strap body 142.

The first strap 130 is preferably comprised of at least one male fastener 132. The fastener 132 may be any male fastener type known in the art. In one embodiment, the fastener 132 is comprised of a pronged fastener.

The second strap 140 is preferably comprised of at least one female fastener 144. The fastener 144 may be any female fastener type known in the art. The female fastener 144 receives the male fastener 132 to allow the first strap 130 to attach to the second strap 140.

While worn by a dog 10, the straps 130, 140 preferably attach at a strap body 142 of the device 100. The strap body 142 is preferably positioned on the back of the dog 110 while the device 100 is worn by the dog 10. In this manner, the device 100 is secured around the dog 10 and can be easily removed by a user from the dog 10.

By covering the underbelly and front chest area of the dog 10, the dog's nipples are covered. As a result, the device 100 can be used to help control a puppy suckling on a mother dog 10. The device 100 can also be used to assist the weaning process between a mother dog 10 and puppies. By hiding the nipples of the mother dog 10, the device 100 creates less anxiety for puppies. In addition, the device 100 also comforts and relaxes the mother dog 10 by eliminating the possibility of puppies trying to nurse on the mother dog 10.

In one embodiment, the strap body 142 is comprised of at least one ring 150. The ring 150 allows a leash to be clipped to the device 100. As a result, the device 100 can also be used as a harness. However, it should be appreciated that the openings 114 do not inhibit the usage of other harnesses in combination with the device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dog-weaning garment device” and “device” are interchangeable and refer to the dog-weaning garment device 100 of the present invention.

Notwithstanding the foregoing, the dog-weaning garment device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dog-weaning garment device 100 as shown in the FIGS. are for illustrative purposes only, and that many other sizes and shapes of the dog-weaning garment device 100 are well within the scope of the present disclosure. Although the dimensions of the dog-weaning garment device 100 are important design parameters for user convenience, the dog-weaning garment device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dog-weaning garment device comprising:
a body;
a pad;
a leg opening;
a body opening;
a first strap comprised of a first fastener; and
a second strap comprised of a second fastener.

2. The dog-weaning garment device of claim 1, wherein the body is comprised of a washable fabric material.

3. The dog-weaning garment device of claim 2, wherein the washable fabric material is comprised of an elastic material or a stretchable material.

4. The dog-weaning garment device of claim 1, wherein the first fastener attaches to the second fastener.

5. A dog-weaning garment device comprising:
a body;
an absorbent pad;
a leg opening;
a body opening;
a first strap comprised of a male fastener; and
a second strap comprised of a female fastener.

6. The dog-weaning garment device of claim 5, wherein the body is comprised of a perforated fabric material.

7. The dog-weaning garment device of claim 5, wherein the leg opening is comprised of an elastic material.

8. The dog-weaning garment device of claim 5, wherein the body opening is comprised of an elastic material.

9. The dog-weaning garment device of claim 5, wherein the first strap is comprised of an elastic material.

10. The dog-weaning garment device of claim 5, wherein the second strap is comprised of an elastic material.

11. A dog-weaning garment device comprising:
a body;
a pad;
a leg opening;
a body opening;
a strap body;
a first strap comprised of a first fastener; and
a second strap comprised of a second fastener.

12. The dog-weaning garment device of claim 11, wherein the body is comprised of an insulated fabric material.

13. The dog-weaning garment device of claim 11, wherein the first strap is adjustable in length via a first adjustment fastener.

14. The dog-weaning garment device of claim 11, wherein the first fastener is comprised of a sliding buckle.

15. The dog-weaning garment device of claim 11, wherein the second strap is adjustable in length via a second adjustment fastener.

16. The dog-weaning garment device of claim 15, wherein the second fastener is comprised of a sliding buckle.

17. The dog-weaning garment device of claim 11, wherein the first fastener is comprised of a pronged male fastener.

18. The dog-weaning garment device of claim 11, wherein the second fastener is comprised of a female fastener.

19. The dog-weaning garment device of claim 11, wherein the second fastener is positioned on the strap body.

20. The dog-weaning garment device of claim 11, wherein the strap body is comprised of a ring.
